(19) United States
(12) Patent Application Publication
(10) Pub. No.: US 2009/0121897 A1
(43) Pub. Date: May 14, 2009

(54) APPARATUS, AND METHOD, FOR FACILITATING PASSAGE AT A LIMITED ACCESS FACILITY

(75) Inventors: JEFF P. MUHLETHALER, WOODSTOCK (CA); PAUL C. DEMEYERE, DORCHESTER (CA); PARIT K. SHARMA, LONDON (CA); JAS S. KAULDHAR, LONDON (CA); MICHAEL A. DENOMME, LONDON (CA)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/940,075

(22) Filed: Nov. 14, 2007

(51) Int. Cl. G08G 1/00

(52) U.S. Cl. 340/908

(57) ABSTRACT

An apparatus, and a method for facilitating control of passage at a security gate, or other secured passageway, at a limited access facility. A scanner is provided that scans the RFID tag. RFID information is detected and its contents are used to access stored information associated with the vehicle. The accessed information is provided to the scanner and displayed on a display screen thereof.

The present invention relates generally to a manner by which to maintain control of vehicular ingress and egress in to and out of a secured area, such as passage through a security gate of a limited-access enterprise, facility. More particularly, the present invention relates to an apparatus, and an associated method, by which to obtain information about vehicles entering or leaving the limited-access facility and to facilitate identifying whether the vehicle should be permitted in to or egress from the facility.

RFID (Radio Frequency Identification) information related to the vehicle and its driver is scanned by a scanner. The scanned information is used to access stored information that is retrieved and displayed. Verification of the vehicle and its operator is quickly made to determine whether the vehicle is permitted passage through the security gate or other passageway leading to or from the limited-access facility.

### BACKGROUND OF THE INVENTION

Business enterprise, and other, facilities regularly maintain some form of security to limit access in to the facility, and egress from the facility. Control over the access to the facility ensures that only those authorized to access the facility are permitted entry to the facility. Many business facilities, for instance, maintain a security staff to man the security gate. All those wanting to enter the facility are generally required first to be granted permission at the security gate in order to be permitted physical access to the facility. Analogously, those desiring to exit the facility must similarly obtain permission to exit the facility by way of the security gate.

Such security requirements are oftentimes in place, not only merely for personnel entry and egress from a limited-access facility but also for vehicles, and their contents. In a typical security gate scenario, a vehicular operator of a vehicle that desires entry to the limited-access facility slows in speed when approaching the security gate and then stops at the security gate. Security personnel at the security gate make a determination as to whether to permit entry of the vehicle by the vehicular operator to the facility. If approval is granted, the security personnel grant the vehicular operator to enter the limited-access facility. In a low-security scenario, physical barriers are not in place, and security personnel merely wave the vehicular operator through the security-gate passageway. In other arrangements, physical barriers limit entry of the vehicle in to the facility. And, upon grant of access of the vehicle to the facility, the physical barrier that blocks entry to the facility is removed, and the vehicular operator is permitted to enter the facility.

When egressing the facility, a corresponding security scenario analogously controls egress from the facility. That is to say, the operator of a vehicle slows down when approaching the security gate prior to exiting the facility. And, upon reaching the security gate, the vehicular operator stops the vehicle to request permission to exit the facility. Security personnel at the security gate decide whether to permit egress of the vehicle. And, if egress of the vehicle is permitted, the vehicular operator is granted permission to exit the facility. Again, in a low-security environment the operator is merely waved through the security gate. In an arrangement in which more stringent security is in place, a physical barrier blocks egress from the facility. Upon grant of egress of the vehicle from the facility the physical barrier is removed and the vehicle is permitted passage through the security gate and away from the facility.

Records of vehicles and persons entering and exiting the facility are regularly made and maintained. Typically, the records are manually created and maintained.

Modern technologies are sometimes utilized to facilitate security procedures pertaining to ingress and egress at a security gate, or other security passageway, of a limited-access facility. For instance, RFID (Radio Frequency Identification) systems utilize tags and readers that operate to transmit the identity of an object or person by way of radio waves. Tags store information on a microchip connected to a radio antenna, and RFID readers emit radio waves that exchange signals with the tags. Information is digitally transferred to a computer. RFID is a type of automatic identification technology. Existing applications that utilize RFID information include, for instance, mass transportation and toll lanes, biometric technologies, etc. While security-gate related systems sometimes make use of RFID technologies, such existing schemes primarily relate to gate access and automation. Existing schemes generally fail to extend RFID technologies to include identification of a vehicular driver or provide for database verification of vehicular or driver information.

As both driver information and information associated with a vehicle are important criteria to be considered when making security ingress and egress decisions, consideration of this information would provide for improved security procedures at a security gate or passageway.

It is in light of this background information related to security systems and schemes that the significant improvements of the present invention have evolved.

### SUMMARY OF THE INVENTION

The present invention, accordingly, advantageously provides an apparatus, and an associated method, by which to maintain control of vehicular ingress and egress in to and out of a secured area, such as a security gate of a limited-access business, or other enterprise facility.

Through operation of an embodiment of the present invention, a manner is provided by which to obtain information about vehicles entering or leaving the limited-access facility and to identify whether the vehicle should be permitted ingress to, or egress from, the facility.

In one aspect of the present invention, RFID (Radio Frequency Identification) information related to a vehicle that is to pass through the security gate is scanned by a portable scanner. The scanned information, once obtained, is used to access stored information. Stored information is available, the information is to verify the vehicle and driver, and an affirmative decision relating to ingress or egress of the vehicle through the secured passageway is permitted.

In one aspect of the present invention, a portable scanner is provided that is capable of reading RFID information related to a vehicle in proximity to the secured passageway. The portable scanner is, e.g., a hand-holdable device, capable of operation by a security guard or other personnel. When an RFID tag is provided with excitation energy, RFID information is read from the tag by a scanner, i.e., an RFID reader. The RFID-tag exciter is positioned proximate to the security passageway and, e.g., forms part of the portable scanner. The operator of the portable scanner, for instance, positions the scanner proximate to a vehicular RFID tag and reads vehicular information associated with the vehicle and, e.g., its characteristics and contents. And, the operator of the scanner, for instance, positions the scanner in proximity to a tag or badge of the vehicular operator and reads operator-related information therefrom.

In another aspect of the present information, i.e., the information read by the scanner, is used to access stored information. The stored information, if available, is retrieved from a database that is maintained relating to ingress to and egress from the limited-access facility. The database is, in one implementation, physically positioned at the portable scanner. In another implementation, the database is maintained remote from the portable scanner, positionable in communication connectivity with the portable scanner.

In another aspect of the present invention, the portable scanner further includes a radio transceiver that operates to send the scanned information to a remote location to correlate with stored information. The stored information related to a vehicle is, for instance, indexed together with a vehicular identifier, such as a VIN (Vehicle ID Number). In one implementation, the stored information is accessed and then sent to the portable scanner and compared at the portable scanner. The radio transceiver element of the portable scanner comprises, for instance, a WLAN (Wireless Local Area Network) device, such as a device operable pursuant to an IEEE 802.11 family of standards, a Bluetooth standard, or any other appropriate and available RF communication scheme.

In another aspect of the present invention, a database is formed and maintained to include information related to vehicular passage through the security passageway. The database information includes, for instance, a history of vehicular ingress and egress in to and out of the limited-access facility. In the event that the facility contains multiple security gates or passageways, the passageway identifies vehicular ingress and egress together with the identification of the passageway through which the vehicle has passed. Analogous information is also collected and maintained with respect to the operator of the vehicle. Information related to the contents of the vehicle, its licensing, and any other information that might be of interest is also stored and maintained at the database. The database is positionable wherever desired, as part of the portable scanner, in proximity to the security passageway, or remote therefrom, connectable by way of a radio, wired, or other connection.

In another aspect of the present invention, the scanned information is compared with the database-retrieved information to verify whether the vehicle should be permitted passage through the passageway. If correspondence is made between the accessed information and the vehicle, its operator, or other retrieved and viewed indicia, the vehicle and the vehicular operator are considered to be authenticated and an affirmative decision to permit ingress and egress of the vehicle is made. In the event that scanned information includes updated information related to the vehicle or its operator, the database is updateable with the updated information. The database thereby is maintained in updated form. And, if no stored information is available, manual input is available by which to input additional information.

In another aspect of the present invention, the portable scanner also includes a display element configured to display verification results. An operator of the scanner is able to view the display and make determination therefrom as to whether the vehicle and its operator should be permitted passage. The scanner operator makes a final determination as to whether to permit ingress or egress of the vehicle. The display, for instance, forms part of a user interface that also includes an input element permitting operator input to confirm ingress or egress of the vehicle as well as other input information. Because the operator of the scanner need not input, such as by way of a keyboard or the like, input information related to the vehicle or its operator, entry errors that might affect the comparison and decisions regarding the secured access or egress do not occur. Improved security procedures are thereby implementable.

In these and other aspects, therefore, an apparatus, and an associated method, is provided for facilitating control of the vehicular passage at a facility vehicular passageway. An RFID information detector is configured to detect vehicular RFID information at the vehicular passageway that pertains to vehicular passage therethrough. An accessor is configured to access stored information associated with the vehicular RFID information detected by the RFID information detector with stored information. A displayer is configured to display display information that includes the stored information.

A more complete appreciation of the scope of the present invention and the manner in which it achieves the above-noted and other improvements can be obtained by reference to the following detailed description of presently preferred embodiments taken in connection with the accompanying drawings which are briefly summarized below, and by reference to the appended claims.

### BRIEF DESCRIPTION OF THE DRAWINGS

FIG. 1 illustrates a functional block diagram of an arrangement extending to a secured passageway extending to a limited-access facility and at which an embodiment of the present invention is operable.

FIG. 2 illustrates a perspective view of a portable unit of an embodiment of the present invention.

FIG. 3 illustrates a method flow diagram representative of an embodiment of the present invention.

### DETAILED DESCRIPTION

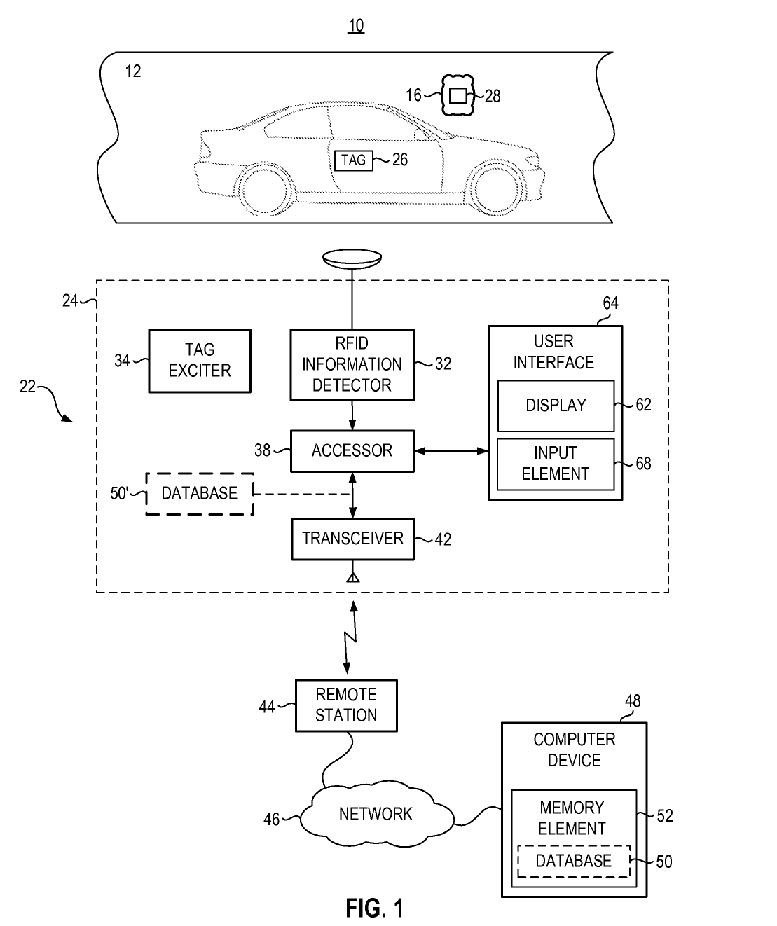

Referring first to FIG. 1, an arrangement, shown generally at 10, illustrates part of a limited-access facility. The facility includes a security gateway 12 that defines a security passageway. The passageway permits passage in to and out of the limited-access facility and is representative, e.g., of a security gate of a business, or other, enterprise. The security passageway here permits ingress in to and egress out of the limited-access facility by vehicles, e.g., trucks and automobiles, operated by vehicular operators. A vehicle 14 and a badge 16, representative of a badge worn by an operator of the vehicle, are positioned at the passageway.

A scanner 22 of an embodiment of the present invention is further shown in FIG. 1. The scanner includes elements that are functionally represented, implemented in any desired manner, including, by algorithms executable by processing circuitry, hardware equivalents, combinations thereof, and hardware circuit elements.

In the exemplary implementation, elements of the scanner are housed within a housing, shown at 24. The portable scanner is used by personnel at the security gate to scan RFID information contained at tags 26 and 28 of the vehicle 14 and badge 16, respectively. The scanner includes an RFID information detector 32 and, in the exemplary implementation, a tag exciter 34. In another implementation, the tag exciter is positioned elsewhere. For instance, the tag exciter is alternately positioned in permanent affixation at the security passageway, so as to provide excitation energy to the RFID tags 26 and 28 when the vehicle and its operator are positioned at the security passageway 12.

In whatsoever implementation, the RFID information detector is positionable, such as positioning by security personnel, or an other operator, of the scanner, to read RFID information from the tags 26 and 28.

In the exemplary implementation, RFID information detected by the detector 32, is provided, here by way of an accessor 38, to a transceiver element 42. The transceiver element operates to transceive communication signals with a remote location, here represented by the remote station 44. And, specifically, the transceiver element operates to send indications of the detected information to the remote station 44.

The remote station, in the exemplary implementation, is connected by way of a network 46, to a device 48, such as a computer server that maintains a database 50 at a memory element 52 thereof. The database includes information related to the passageway 12 and, particularly, the vehicles and operators (permitted to pass, or prohibited from passing) therethrough. In operation, the data base is accessed, using, e.g., information provided by the detector. And, the accessed information is retrieved, provided, by way of the network 46, to the communication station 44 and, in turn, the remote station sends the accessed information to the scanner 22, received by the receive part of the transceiver element 42.

In the exemplary implementation, the accessor operates to access the information stored at the database. Accessed information is provided by the accessor to a display element 62 of a user interface 64. In the event that stored information associated with the detected information does not exist or is otherwise unavailable, a corresponding no-match indication is displayed at the display element 62. Security personnel are then able, if desired, to prohibit or permit passage of the vehicle through the security passageway without use of stored information.

The user interface 64 further includes an input element 68, such as an interactive screen icon. The input element is actuated by an operator of the scanner, e.g., to acknowledge the display made at the display element 62 and, e.g., to identify that the vehicle has passed through the secured passageway. Such an indication, in the exemplary implementation, is further provided to the transceiver element 42 and communicated to the remote station, through the network 46, and used to update the database 50 formed at the device 48. Additional information is also, for instance, provided to the database to maintain the up-to-date status of the database. The database, in one implementation, forms a listing of permitted and non-permitted vehicles and vehicular operators. And, in one implementation, the listing further contains additional information associated with the vehicle, such as the contents of the vehicle, and additional information associated with the operator who wears the badge 16. In one implementation, this information is accessed, retrieved, and provided to the scanner for display at the display element 62. Security personnel analyze the displayed information to confirm, such as by a visual comparison, that the vehicle and operator correspond with the displayed information.

In the event that stored information is unavailable or is in need of update, the input element is further used to manually input the additional information.

In other implementations, various elements of the scanner as well as other elements shown in the arrangement 10 are physically located elsewhere. For instance, in one implementation, the database 50, or a copy of at least a part thereof, is maintained at the scanner. Remote access to the database is not required in such an implementation. The database 50, shown in dash, is representative of this implementation. And, e.g., in another implementation, the functions of the verifier are carried out elsewhere, such as at the device 48 rather than at the scanner. Other elements are analogously also physically positionable at other locations and used in other manners. The operation described with respect to the implementation shown in FIG. 1 is merely exemplary.

In a typical operational scenario, a vehicle is driven to the security gate formed of the secured passageway 12 and stops to await authorization to enter the limited-access facility. A security card at the security gate obtains RFID information associated with the vehicle and its operator by reading RFID information from the tags 26 and 28. The detected information is sent to the remote location, and the corresponding database information is obtained from the database 50. The obtained database information is returned to the scanner and is displayed at the display element 62. The security guard makes a final decision to permit passage of the vehicle through the gateway or deny passage of the vehicle through the gateway. And, the security guard further actuates the input element 68 to confirm the decision and, if needed, to update the database of the decision made by the security guard. The database thereby further maintains an updated listing of all vehicles that are within the confines of the limited-access facility.

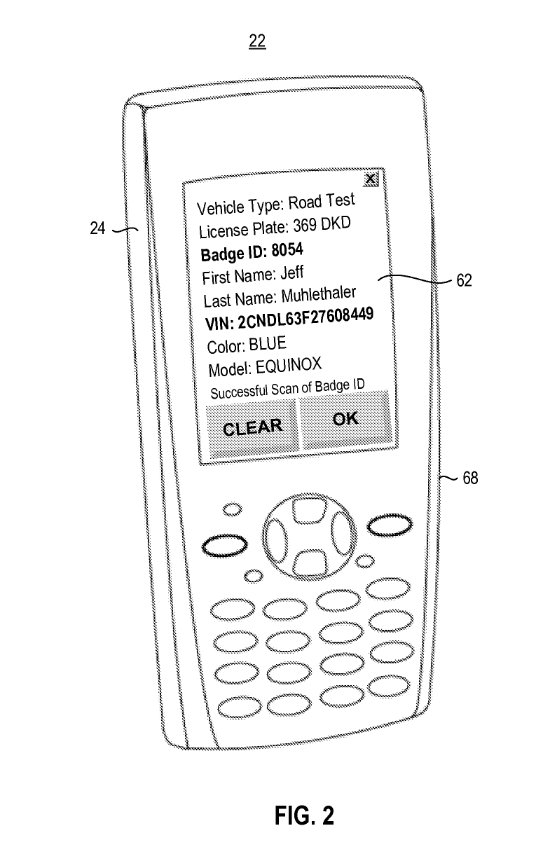

FIG. 2 illustrates a perspective view of the scanner 22 that forms part of the arrangement 10 shown in FIG. 1. Elements of the scanner are supported by the housing 24 that supportively houses various elements of the scanner therein and supportively positions the display 62 to permit viewing thereof such as by an operator of the scanner. The actuation keys of the input element 68 are also supported at the housing 24, positioned to permit actuation thereof to input information. As illustrated in the Figure, the display element includes a “clear” icon and an “ok” icon that identifies inputs that are made by an operator of the scanner responsive to detected information that is verified by a verifier. Additional input keys of the input element 68 are used for additional purposes, such as to input additional information. The display element 62, in the exemplary implementation, further displays information associated with a vehicle and its vehicular operator that is positioned at the security gate to enter in to or exit from the limited-access facility.

RFID tags at the vehicle, and mounted on a badge, or otherwise worn by an operator of the vehicle are excited and provided RFID information that is detected at the scanner. Values identifying the detected RFID information are sent to a database. The database associates the RFID tag, based upon its detected information, with a specific value or license plate. In the exemplary implementation, when the RFID tag is excited, the scanner 22 is pre-populated with scanned information, such as vehicular and license plate data. The scanner is then used, if needed, to input additional data to complete a vehicular record. For instance, driver data is obtained. The drivers' badge, e.g., is scanned, and a data base lookup is executed. Information returned from the database is displayed on the scanner and can be used by the security personnel to verify the identity of the driver by, e.g., name of the driver, position, identity characteristics, such as height, weight, age eye color, gender, etc. And, VIN (Vehicular Identification Number) data is also obtained. The VIN of the vehicle is scanned, and a database looked up is executed.

Information returned from the database is displayed on the scanner and thereby made available to the security personnel to verify the identity of the vehicle by, e.g., its make, model, color, year, and option. Such a procedure is particularly helpful when an RFID tag is attached and associated with a roaming dealer plate that is used on multiple vehicles.

Once the driver data and the vehicular data are successfully verified, the security personnel or other operator of the scanner completes the record by selecting the “ok” button, and the vehicle enters or exits the facility and the vehicle enter or exit record is completed. Thereby, manual data entry is eliminated in the processing of vehicular traffic while maintaining complete and accurate records that are available across an enterprise.

In a further implementation, multiple arriving vehicles that arrive at a security gate or other passageway are held in a queue. If the RFID tag of the vehicle is excited while another vehicle is being processed with the scanner, the information of that vehicle is queued in FIFO (First In, First Out) order at a memory cache of the scanner. After processing of a prior vehicle has been completed, the scanner is pre-populated with information related to the following vehicle in the queue.

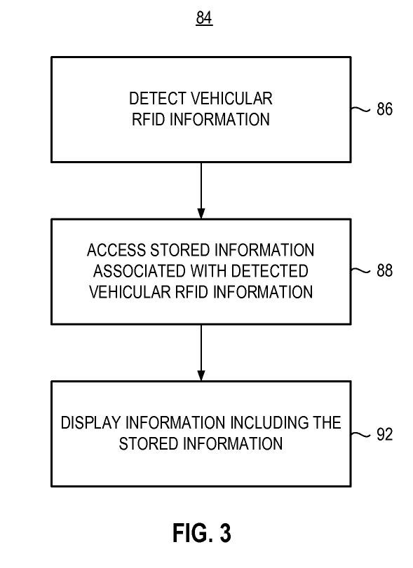

FIG. 3 illustrates a method flow diagram representative of the method of operation of an embodiment of the present invention. The method, shown generally at 84, facilitates control of vehicular passage at a facility vehicular passageway.

First, and as indicated by the block 86, vehicular RFID information is detected at the vehicular passageway pertaining to vehicular passage therethrough. Then, and as indicated by the block 88, correspondency of the vehicular RFID information is verified. And, display information is displayed together with a verification indication.

The conventional need of security personnel manually to enter large amounts of information is avoided. And, the resulting problems associated erroneous entry of information is also avoided.

Presently preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. Apparatus for facilitating control of vehicular passage at a facility vehicular passageway, said apparatus comprising:
an RFID information detector configured to detect vehicular RFID information at the vehicular passageway pertaining to vehicular passage therethrough;
an accessor configured to access stored information associated with the vehicular RFID information detected by said RFID information detector; and
a displayer configured to display information that includes stored information, if any, accessed by said accessor.

2. The apparatus of claim 1 wherein said RFID information detector is configured to detect vehicular RFID information responsive to excitation thereof.

3. The apparatus of claim 1 wherein the vehicular RFID information further comprises driver RFID information.

4. The apparatus of claim 1 wherein the vehicular RFID information comprises vehicle-identification RFID information.

5. The apparatus of claim 1 wherein said RFID information detector comprises a hand-holdable RFID information detector.

6. The apparatus of claim 1 further comprising a supportive housing and wherein said RFID information detector and said displayer are supported at said supportive housing.

7. The apparatus of claim 6 wherein said accessor is further supported at said supportive housing.

8. The apparatus of claim 1 wherein the stored information comprises database retrieved information.

9. The apparatus of claim 1 further comprising a memory element configured to store database information forming the saved information.

10. The apparatus of claim 9 wherein said accessor further comprises a database updater configured to update the stored data responsive to detection made by said RFID information detector.

11. The apparatus of claim 10 wherein the display information displayed by said displayer comprises database information retrieved from said memory element.

12. The apparatus of claim 1 wherein the display information displayed by said displayer further comprises a representation of the vehicular RFID information detected by said RFID information detector.

13. The apparatus of claim 1 wherein the display information further identifies whether stored information is associated with the RFID information detected by said RFID information detector.

14. The apparatus of claim 1 wherein said displayer further comprises an alerter configured to generate an alert when accessor fails to obtain the stored information.

15. A method for facilitating control of vehicular passage at a facility vehicular passageway, said method comprising:
detecting vehicular RFID information at the vehicular passageway pertaining to vehicular passage therethrough;
accessing stored information associated with the vehicular RFID information detected during said detecting; and
displaying display information that includes stored information accessed during said accessing the stored information.

16. The method of claim 15 wherein said detecting the vehicular RFID information comprises scanning the vehicular RFID information.

17. The method of claim 16 wherein said scanning further comprises scanning vehicular driver RFID badge information.

18. The method of claim 15 further comprising maintaining a database that contains vehicular RFID information.

19. The method of claim 15 further comprising inputting acknowledgment of vehicular passage through the facility vehicular passageway

20. Apparatus for facilitating control of gate-entry and gate-egress of a vehicle to a secured facility, said apparatus comprising:
an RFID scanner configured to scan vehicular RFID information of the vehicle at the secured facility;
an information obtainer adapted to receive scanned vehicular RFID information, said information obtainer configured to obtain additional information associated with the scanned vehicular RFID information to facilitate verification of authorization of the vehicle at the secured facility; and
a reporter configured to report in human perceptible form the additional information obtained by said information.
